(19) United States
(12) Patent Application Publication
(10) Pub. No.: US 2016/0342915 A1
(43) Pub. Date: Nov. 24, 2016

(54) Autonomous Fleet Size Management

(71) Applicant: Caterpillar Inc., Peoria, IL (US)

(72) Inventor: James Humphrey, Decatur, IL (US)

(73) Assignee: Caterpillar Inc., Peoria, IL (US)

(21) Appl. No.: 14/719,515

(22) Filed: May 22, 2015

(51) Int. Cl. G06Q 10/06; G01C 21/34; G07C 5/00; G05D 1/00

(52) U.S. Cl. CPC G06Q 10/06313; G05D 1/0027; G01C 21/3407; G07C 5/008; G05D 2201/021

(57) ABSTRACT

A system for managing a fleet of vehicles, the system including a work site including a plurality of vehicles; a plurality of autonomous vehicles, each autonomous vehicle including an electronic processing unit configured to transmit data to a second location; a first location with an electronic processing unit configured to transmit data to the second location; and the second location with an electronic processing unit configured to determine, in response to the data transmitted by the plurality of autonomous vehicles and the first location, whether the first location is available to service a vehicle, the electronic processing unit of the second location is further configured to dispatch at least one autonomous vehicle to the first location if the first location in the work site is underserved by vehicles, and to deactivate at least one autonomous vehicle serving the first location if the first location in the work site is overserved by vehicles is disclosed.

### TECHNICAL FIELD

This patent disclosure relates generally to managing an autonomous fleet of vehicles and, more particularly, to a system and method for increasing work site efficiency.

### BACKGROUND

In a number of industries, vehicles or other transportation methods are used to pick up loads from one location and deliver the loads to another location. Some exemplary industries that work within this model include shipping, package delivery, and taxi-cabs. This model has particular application in the mining industry, where material transportation involves a vehicle picking up a load of ore from a shovel site and transporting that ore to a processing site. Additionally, processed ore may need to be transported to a site of additional processing. Because of this, material transport is one of the most important aspects in the mining industry and can represent 50-60% of costs associated with open-pit mining.

Even a slight reduction in costs associated with material transport may result in significant savings. Thus, a dispatching system for controlling the vehicles within a mine may be used to optimize material transport and reduce costs. For example, vehicles may include an articulating truck, a haul truck, a personnel carrier, a remix truck, a shuttle car, or a water truck. For example, a mining site may have multiple shovels and multiple processing sites. A shovel, broadly defined, encompasses any piece of equipment that delivers a load to a vehicle. For example, shovels may include a bulldozer, a dragline, track loaders, wheel loaders, a motor grader, a mass excavator, a scraper, an electric shovel, a hydraulic shovel, a continuous miner, a scaler, or a scooptram. A processing site, broadly defined, encompasses any machine which may process mined ore or other materials delivered to it. For example, a processing site may include crusher machines, waste storage sites, or ore storage sites. Variability during mining operations may cause vehicles to arrive at shovels or processing sites at irregular intervals, which may cause bunching of vehicles in one part of a transportation cycle. This bunching may result in the shovels, the processing sites, or both being served by either too few or too many vehicles. This may result in inefficient operation of the work site. Historically, one solution was to schedule excess manned, or non-autonomous, vehicles in case a shovel or a processing site was underserved by vehicles. However, this results in increased costs and waste, such as additional fuel burn, increased carbon production, and unutilized or underutilized personnel and capital equipment because these additional vehicles and employees may not be needed. Additionally, the number of operators would have to match the number of non-autonomous trucks. Also, the non-autonomous vehicles may take 20 to 30 minutes to start, which makes it difficult for non-autonomous vehicles to fill in a momentary gap.

U.S. Pat. No. 6,741,921 (“the '921 patent”), entitled “Multi-Stage Truck Assignment System and Method” addresses the problem of generating a dispatch assignment and assigning the dispatch assignment to each vehicle. The '921 patent describes generating dispatch assignments for vehicles based on the current environment and optimal criteria information. The design of the '921 patent, however, may still result in an inefficient allocation, for example, of vehicles to shovels or processing sites because of momentary variability. These and other shortcomings of the prior art are addressed by this disclosure.

### SUMMARY

In one aspect, this disclosure describes a method for managing a fleet of vehicles, the method comprising: receiving data regarding a work site at an electronic processing unit at a first location, wherein the work site comprises a plurality of vehicles; and determining, at the electronic processing unit and in response to the received data, whether a second location in the work site is available to service a vehicle, dispatching, via the electronic processing unit, at least one autonomous vehicle to the second location if the second location in the work site is underserved by vehicles, and deactivating, via the electronic processing unit, at least one autonomous vehicle serving the second location if the second location in the work site is overserved by vehicles.

In another aspect, this disclosure describes a system for managing a fleet of vehicles, the system comprising a work site comprising a plurality of vehicles; a plurality of autonomous vehicles, each autonomous vehicle comprising an electronic processing unit configured to transmit data to a second location; a first location with an electronic processing unit configured to transmit data to the second location; and the second location with an electronic processing unit configured to determine, in response to the data transmitted by the plurality of autonomous vehicles and the first location, whether the first location is available to service a vehicle, the electronic processing unit of the second location is further configured to dispatch at least one autonomous vehicle to the second location if the second location in the work site is underserved by vehicles, and to deactivate at least one autonomous vehicle serving the second location if the second location in the work site is overserved by vehicles.

### BRIEF DESCRIPTION OF THE DRAWINGS

FIG. 1 is a diagrammatic illustration of a work site, according to one aspect of this disclosure.

FIG. 2 is a block diagram illustrating the overall system, according to one aspect of this disclosure.

FIG. 3 is a block diagram of a computing system located at a central site, according to one aspect of this disclosure.

FIG. 4 is a block diagram of a computing system located on an autonomous vehicle, according to one aspect of this disclosure.

FIG. 5 is a flowchart executed by the computing system located at the shovel, according to one aspect of this disclosure.

FIG. 6 is a flowchart executed by the computing system located at the autonomous vehicle, according to one aspect of this disclosure.

FIG. 7 is a flowchart executed by the computing system located at the central site, according to one aspect of this disclosure.

### DETAILED DESCRIPTION

Reference will now be made in detail to aspects of this disclosure, examples of which are illustrated in the accompanying drawings. Wherever possible, the same reference numbers will be used throughout the drawings to refer to the same or like parts throughout. Additionally, a work site may have a plurality of autonomous vehicles, a plurality of non-autonomous vehicles, a plurality of shovels, and a plurality of processing sites. While this disclosure will describe aspects of a system and a method with one autonomous vehicle, one non-autonomous vehicle, one shovel, and one processing site, this disclosure should not be understood to be limited to such.

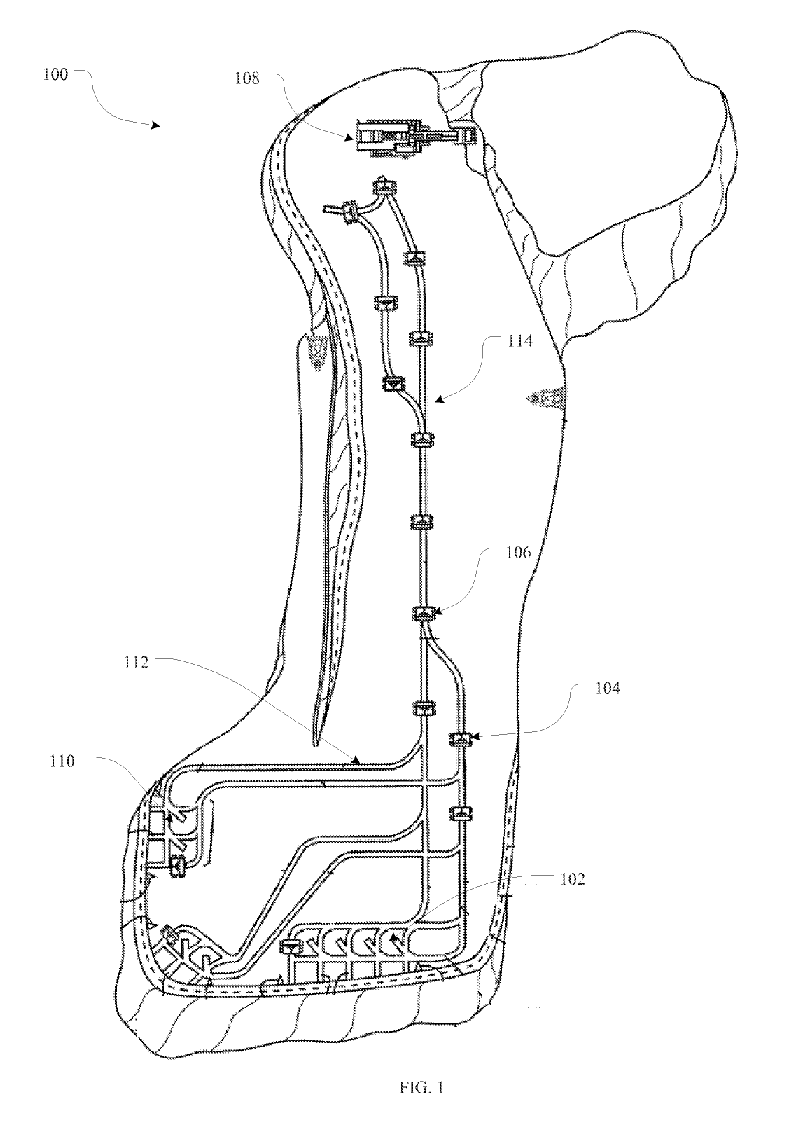

In general, and in reference to FIGS. 1-3, this disclosure comprises a central site 102 in a work site 100, such as a mine, with a computing system 300. The work site 100 comprises a plurality of shovels 108 and a plurality of processing sites 110, such as crushers. Vehicles, both autonomous and non-autonomous, transport material from the plurality of shovels 108 to the plurality of processing sites 110. However, during normal operation of the work site 100, there may be variations in vehicle cycle time from a shovel 108 to a processing site 110 and back to the shovel 108. For example, a shovel 108 or a processing site 110 may fail to operate correctly or load or unload a vehicle 104 and 106 more slowly than anticipated, which may delay vehicles 104 and 106. Additionally, there may be variations caused by in route congestion. In route congestion may be caused, for example, by a failed vehicle traversing a route. If a vehicle fails along its route, it may delay vehicles behind it from reaching their destination on time. These variations may result in vehicles 104 and 106 “bunching” in one area of the work site 100. This bunching may result in one or more shovels 108 or processing sites 110 being underserved by trucks 104 and 106. Thus, the efficiency of the shovel 108, and the work site 100 as a whole, is reduced. To prevent the work site 100 from operating in a less efficient manner, the computing system 300 located at the central site 102 in the work site 100 may determine that a shovel 108 or processing site 110 is underserved on a moment by moment basis. To prevent the shovel 108 or processing site 110 from being underserved, the computing system 300 at the central site 102 may deploy one or more autonomous vehicles 104 to the underserved shovel 108 or processing site 110. Alternatively, if the computing system 300 determines that there are too many vehicles 104 and 106 within the work site 100, the computing system 300 may remove one or more autonomous vehicles 104 from the work site 100.

FIG. 1 is a diagrammatic illustration of the work site 100, according to one aspect of this disclosure. The worksite 100 may include, for example, a mine site, a landfill, a quarry, a construction site, or any other type of worksite areas known in the art. The predetermined tasks may be associated with altering the current geography at the worksite 100 and include a clearing operation, a leveling operation, a hauling operation, a digging operation, a loading operation, a dumping operation, or any other type of operation that functions to alter the current geography at the worksite 100.

The worksite 100 may include multiple locations designated for particular purposes. For example, a first location may be designated as a shovel location, at which a shovel 108 or other resource operates to fill multiple vehicles 104 and 106 with material. A second location may be designated as a processing site, at which the vehicles 104 and 106 may discharge their payloads.

The autonomous vehicles 104 and non-autonomous vehicles 106 may be located at one section of the work site when idle. Alternatively, the autonomous vehicles 104 and non-autonomous vehicles 106 may be located at multiple areas throughout the work site 100 when idle. The autonomous vehicles 104 and non-autonomous vehicles 106 may travel to the shovel 108 or the processing site 110 via a road 112. The road 112 may be segmented into multiple segments 114. Each segment 114 may have a certain length and a certain grade associated with it.

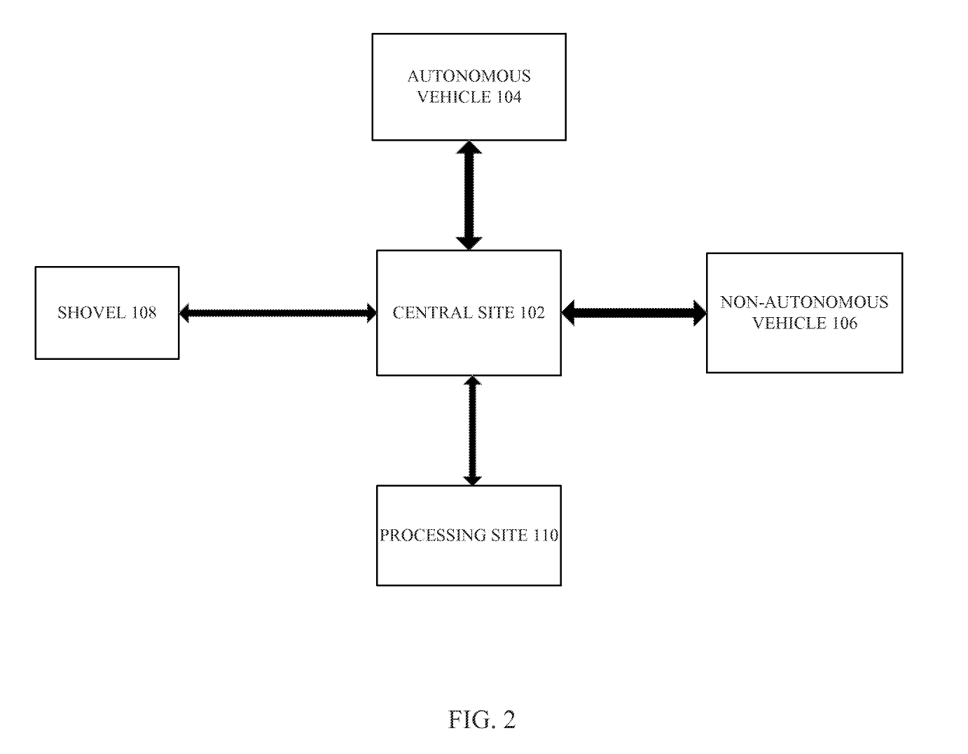

FIG. 2 is a block diagram illustrating the overall system 200, according to one aspect of this disclosure. FIG. 2 illustrates the central site 102, the plurality of autonomous vehicles 104, the plurality of non-autonomous vehicles 106, the plurality of shovels 108, and the plurality of processing sites 110. The central site 102, the plurality of autonomous vehicles 104, the plurality of non-autonomous vehicles 106, the plurality of shovels 108, and the plurality of processing sites 110 may have their own computing systems. Each member of the plurality of autonomous vehicles 104 may have its own computing system 400. Likewise, each member of the plurality of non-autonomous vehicles 106, the plurality of shovels 108, and the plurality of processing sites 110 may have its own computing system. Additionally, the computing system 300 at the central site 102 may be a distributed computing system.

The central site 102 receives information generated by the plurality of autonomous vehicles 104, the plurality of non-autonomous vehicles 106, the plurality of shovels 108, and the plurality of processing sites 110. The central site 102 may also send instructions to the autonomous vehicles 104, non-autonomous vehicles 106, shovels 108, and processing sites 110. The computing system 300 located at the central site 102 may use the information gathered to determine if, and where, to deploy autonomous vehicles 104 or to extract autonomous vehicles 104 from the work site 100. Once the computing system 300 has made the determination, the computing system 300 may transmit that information to the plurality of autonomous vehicles 104. For example, if the computing system 300 determines that one or more of the shovels 108 is underserved, the computing system 300 may transmit an instruction to one or more of the autonomous vehicles 104 instructing the autonomous vehicle 104 to activate. The computing system 300 may also instruct the autonomous vehicle 104 to travel to the underserved shovel 108 along with a route the autonomous vehicle 104 may travel. The computing system 300 may also instruct the autonomous vehicle 104 to travel to the processing site 110 and the route the autonomous vehicle 104 may take to travel from the shovel 108 to the processing site 110. Alternatively, if, for example, the computing system 300 determines that one or more of the shovels 108 is overserved, the computing system 300 may transmit an instruction to one or more of the autonomous vehicles 104 instructing the autonomous vehicle 104 to discontinue serving the shovel 108. The computing system 300 may make similar determinations regarding the processing sites 110.

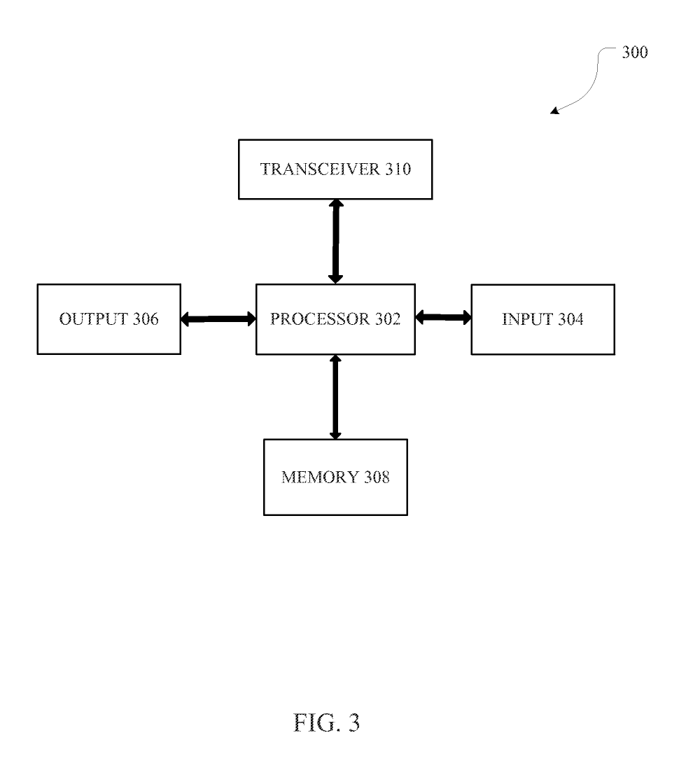

FIG. 3 is a block diagram of a computing system 300 located at the central site 102, according to one aspect of this disclosure. The computing system 300 may comprise a processor 302, one or more inputs 304, one or more outputs 306, memory 308, and one or more transceivers 310. The one or more inputs 304 may be a keyboard, a mouse, a touchscreen, a joystick, a microphone, or any other suitable input mechanism. A user using the computing system 300 at the central site 102 may use the input 304 to input instructions to the processor 302. Such instructions may include deploying one or more autonomous vehicles 104 or extracting one or more autonomous vehicles 104 from the work site 100. The one or more outputs 306 may comprise a display, a speaker, or both. The output 306 may display a map of the work site 100, locations of some or all of the vehicles 104 and 106 operating at the work site 100, locations of the shovels 108, locations of the processing sites 110, routes the vehicles 104 and 106 may take, or speed of the vehicles 104 and 106 on the routes. The output 306 may display all of this information, some of this information, or additional information. Additionally, the output 306 may be manipulated by a user using the one or more inputs 304 to display only selected information. The memory 308 may store instructions the processor 302 may execute to carry out one aspect of this disclosure. The instructions the processor 302 may execute will be further described herein. The computing system 300 may also comprise one or more transceivers 310. The transceiver 310 may transmit information, including instructions, to one or more autonomous vehicles 104. Alternatively, the transceiver 310 may receive information from one or more autonomous vehicles 104, one or more non-autonomous vehicles, one or more shovels 108, or one or more processing sites 110. The transceiver 310 may transmit this information to the processor 302. The processor 302 may process this information, it may store it in memory 308, or it may output this information using output 306.

The computing system located at a shovel 108 also comprises a processor, one or more inputs, one or more outputs, a memory, and one or more transceivers. For example, if the shovel 108 is not operating in the manner it was designed to operate, the one or more outputs may display a user information or an alert that the shovel 108 is not operating in the manner it was designed to operate. For example, the shovel 108 may have become broken. The memory may comprise a computer readable memory to store instructions the processor may execute, according to one aspect of this disclosure. The instructions the processor may execute are further described herein. The memory may also store information relating to performance metrics of the shovel 108. The performance metrics may include current performance metrics, historical performance metrics, or both. For example, the memory may store information related to a demand rate of the shovel 108 for vehicles 104 and 106.

The processing site 110 has a computing system similar to that of shovel 108 and it operates in a similar manner.

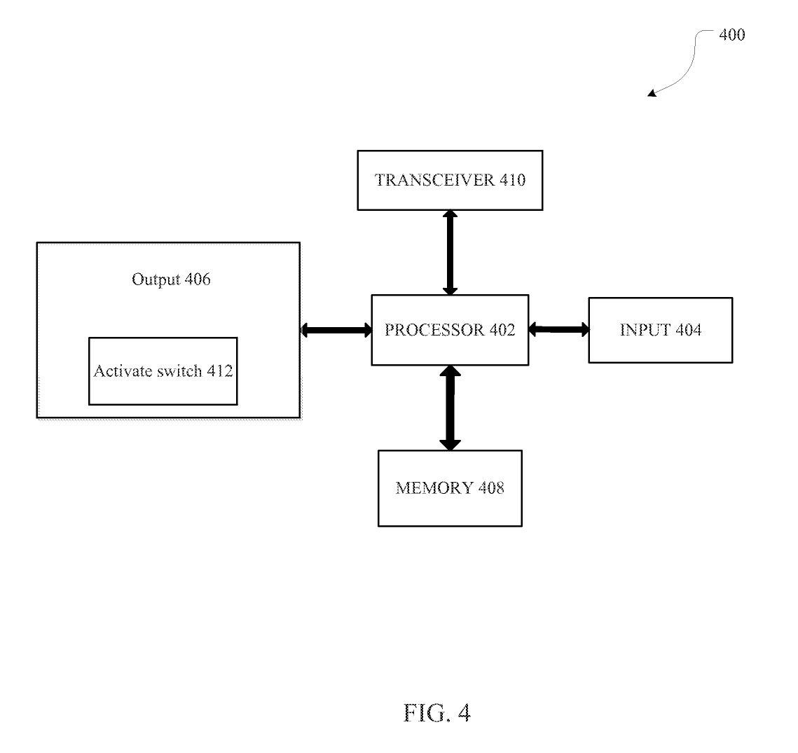

FIG. 4 is a block diagram of a computing system 400 located on the autonomous vehicle 104, according to one aspect of this disclosure. The computing system 400 may comprise a processor 402, one or more inputs 404, one or more outputs 406, memory 408, one or more transceivers 410, and an activate switch 412. The one or more inputs 404 may comprise a keyboard, a mouse, a touchscreen, a joystick, a microphone, or any other suitable mechanism to allow a user to input information into the processor 402 for processing. The one or more inputs 404 may also comprise one or more sensors. The one or more sensors may comprise, for example, an engine coolant temperature sensor, a Hall effect sensor, a Manifold Absolute Pressure (MAP) sensor, a mass flow sensors, an oxygen sensor, a parking sensor, a speedometer, a tire-pressure monitoring sensor, and a water sensor. The one or more sensors may input the sensed parameters into the processor 402 for processing. The one or more outputs 406 may comprise a display, a speaker, or both. The output 406 may display information regarding the autonomous vehicle 104 to a user. The one or more outputs 406 may also display information regarding the work site 100 to a user. Additionally, the one or more outputs may comprise an activate switch 412. The activate switch 412 may be implemented in hardware or software. The activate switch 412 may activate the autonomous vehicle 104 from an idle state. Alternatively, if the autonomous vehicle 104 is active, the activate switch 412 may deactivate the autonomous vehicle 104 to place it in the idle state. The memory 408 may comprise a computer readable memory to store instructions the processor 402 may execute, according to one aspect of this disclosure. The instructions the processor 402 may execute are further described herein. Additionally, the memory 408 may store data or instructions received via the one or more transceivers 410. The memory 408 also may store data gathered or sensed by the one or more inputs 404. The memory 408 may store data to be output by the one or more outputs 406. The one or more transceivers 410 communicate with the central site 102 via the one or more transceivers 310. The one or more transceivers 410 may transmit data from the processor 402 to the computing system 300. Additionally, the one or more transceivers 410 may receive data from the computing system 300 for the processor 402.

The autonomous vehicle 104 may transmit information about a state, location, travel, and health information regarding the autonomous vehicle 104. Information about the state of the autonomous vehicle 104 may include whether the autonomous vehicle 104 is loaded or empty. It may also include what type of load it is carrying, for example, ore or waste. Any appropriate sensor coupled to the autonomous vehicle 104 may be used to generate a signal indicative of the state of the autonomous vehicle 104. Information about the location of the autonomous vehicle 104 may be based on a location sensor, such as a global navigation satellite system (GNSS) sensor. Travel information regarding the autonomous vehicle 104 may be gathered using various sensors coupled to the autonomous vehicle 104. For example, the autonomous vehicle 104 may gather information about its speed using a speedometer. Alternatively, the autonomous vehicle 104 may generate information about its speed using successive GNSS signal measurements. The autonomous vehicle 104 may also transmit its direction of travel using successive GNSS signals. The processor 402 may generate the direction of travel based on a line formed by two successive GNSS signals. Alternatively, instead of the autonomous vehicle 104 generating the direction of travel, the processor 302 at the central site 102 may generate the direction of travel based on the successive GNSS signals received from the autonomous vehicle 104.

Additionally, the autonomous vehicle 104 may be remotely activated using activate switch 412 after receiving an instruction to activate from the central site 102. For example, if the processor 302 at the central site 102 determines that an additional autonomous vehicle 104 would be beneficial, the processor 302 may transmit an instruction, via the one or more transceivers 310, to the autonomous vehicle 104 to activate. In addition to receiving instructions to activate, the autonomous vehicle 104 may also receive routing instructions. The routing instructions may instruct the autonomous vehicle 104 to travel along a given route to a shovel 108 or a processing site 110. Alternatively, if the autonomous vehicle 104 is active and serving a shovel 108 or a processing site 110, the autonomous vehicle 104 may receive instructions from the processor 302 located at the central site 102 to deactivate using the activate switch 412. The autonomous vehicle 104 may receive instructions to travel to a deactivated autonomous vehicle location. The autonomous vehicle 104 may also receive routing instructions from the central site 102 to direct the autonomous vehicle 104 from its current location to the deactivated autonomous vehicle location.

Moreover, the autonomous vehicle 104 may transmit maintenance information to the central site 102. For example, the autonomous vehicle 104 may use an engine coolant temperature sensor to determine a temperature of an engine of the autonomous vehicle 104. If the processor 402 of the autonomous vehicle 104 determines that the engine temperature exceeds a threshold, such as a safety threshold, the processor 402 may transmit via the one or more transceivers 410 to the computing system 300 a warning or indication that the autonomous vehicle 104 must undergo maintenance. Additionally, or alternatively, there may be a tons transported per mile per hour limit for the tires of the autonomous vehicle 104. If the autonomous vehicle 104 exceeds this limit, or is nearing this limit, the computing system 300 may instruct the autonomous vehicle 104 to deactivate. The autonomous vehicle 104 may perform similarly regarding other aspects of vehicle maintenance, including refueling.

The non-autonomous vehicle 106 has a computing system similar to that of autonomous vehicle 104 and it operates in a similar manner. However, the non-autonomous vehicle computing system may not include an activate switch 412.

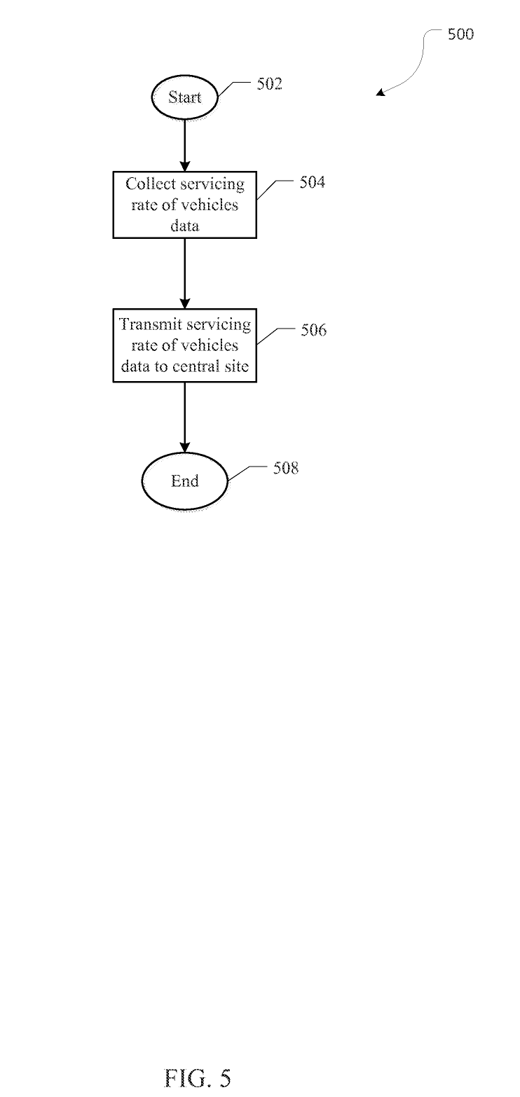

FIG. 5 is a flowchart 500 executed by the computing system located at the shovel 108, according to one aspect of this disclosure. The flowchart begins at 502 and may proceed to 504.

At 504, the computing system may collect performance metrics of the shovel 108 or the processing site 110. Performance metrics may include, for example, the length of time it takes to service one autonomous vehicle 104 or one non-autonomous vehicle 106. One way a shovel 108 may service an autonomous vehicle 104 or a non-autonomous vehicle 106 is by loading the vehicle 104 or 106 with material. One way a processing site 110 may service a vehicle 104 or 106 is to unload the material the vehicle 104 or 106 may be transporting. The performance metrics may be instantaneous. For example, the shovel 108 may time how long it is taking to load the vehicle 104 or 106 it is currently servicing. Also, the processing site 110 may time how long it is taking to unload the vehicle 104 or 106 it is currently servicing. Alternatively, or additionally, to collecting instantaneous performance metrics is to store historical performance metrics. Once the shovel 108 or processing site 110 has collected the performance metrics, the method may proceed to step 506.

At 506, the shovel 108 or the processing site 110 may transmit the performance metrics collected at 504 to the computing system 300. The shovel 108 and the processing site 110 may use the transceivers in the computing system 300. The transmitted performance metrics may include the instantaneous performance metrics, historical performance metrics, or both. After the performance metrics are transmitted from the shovel 108 or processing site 110 to the computing system 300, the method may end at 508.

For example, this method may be executed by a shovel 108 or a processing site 110 located within a mining work site. In the context of a shovel 108, the shovel 108 loads vehicles 104 and 106 with material, such as mined ore. The shovel 108 measures and records information relating to how long it takes for the shovel 108 to load one vehicle 104 or 106 with mined ore. Additionally, or alternatively, the shovel 108 may measure the rate at which the shovel 108 performs work. For example, the shovel 108 may perform work more slowly because, for example, the shovel 108 may be mining a harder block. Additionally, the shovel 108 may also measure and record information relating to the health of the shovel 108. For example, the shovel 108 may measure and record whether it is operating correctly. After the shovel 108 has measured and recorded some or all of this information, it may transmit the information to the computing system 300 located at the central site 102. In addition to transmitting the most recently measured and recorded data, the shovel 108 may also transmit previously recorded data, such as data from the past three days. The shovel 108 executes this process until it is no longer operating because, for example, the mine has closed or if the shovel 108 is undergoing maintenance and needs to be shut down.

The processing site 110, which may also be located within a mining work site, operates similarly. The processing site 110 may measure and record information relating to how long it takes for the processing site 110 to unload one vehicle 104 or 106 with mined ore. Additionally, or alternatively, the processing site 110 may measure the rate at which the processing site 110 performs work. For example, the processing site 110 may perform work more slowly because, for example, the type of material it is unloading. Additionally, the processing site 110 may also measure and record information relating to the health of the processing site 110. For example, the processing site 110 may measure and record whether it is operating correctly. After the processing site 110 has measured and recorded some or all of this information, it may transmit the information to the computing system 300 located at the central site 102. In addition to transmitting the most recently measured and recorded data, the processing site 110 may also transmit previously recorded data, such as data from the past three days. The processing site 110 executes this process until it is no longer operating because, for example, the mine has closed or if the processing site 110 is undergoing maintenance and needs to be shut down.

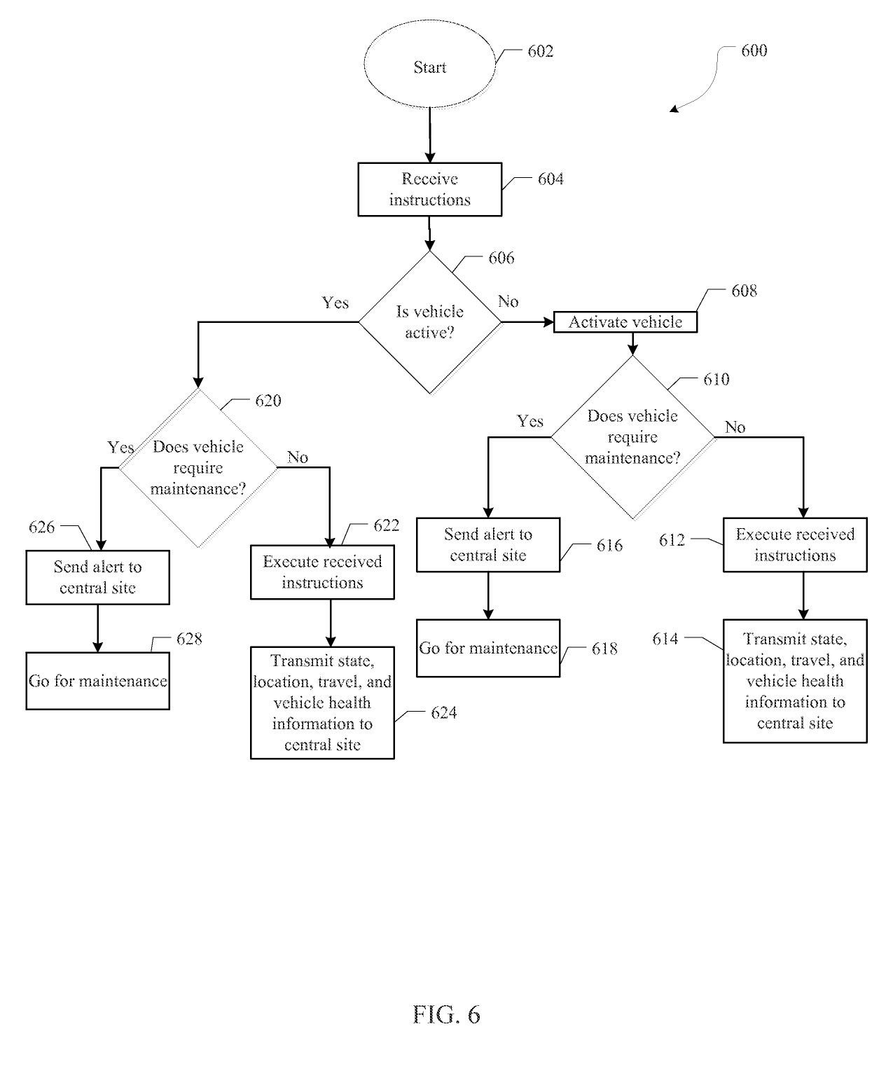

FIG. 6 is a flowchart 600 executed by the computing system 400 located at the autonomous vehicle 104, according to one aspect of this disclosure. The method begins at 602 and may proceed to 604.

At 604, the autonomous vehicle 104 may receive instructions from the central site 102. After receiving the instructions, the method may proceed to 606. The instructions may include an instruction to activate the autonomous vehicle 104, an instruction to deactivate the autonomous vehicle 104, an instruction to travel to a certain shovel 108 or processing site 110, or an instruction providing the route the autonomous vehicle 104 may take to travel to a certain shovel 108 or processing site 110.

At 606, the computing system 400 may determine whether the autonomous vehicle 104 is active. The computing system 400 may use the one or more inputs 404 to determine whether the autonomous vehicle 104 is active or idle. If the autonomous vehicle 104 is not engaged in transporting material, it may be considered to be inactive or idle. For example, a load cell may be coupled to the autonomous vehicle 104 to measure if a force is being applied by any loaded material. Hydraulic load cells, pneumatic load cells, and strain gauge load cells may be used. If the computing system 400 determines that the autonomous vehicle 104 is idle, the method may proceed to 608.

At 608, the processor 402 of the autonomous vehicle 102 may instruct the activate switch 412 to activate the autonomous vehicle 102. Activating the autonomous vehicle 104 may include starting the engine of the autonomous vehicle 104. It may also include setting a route to the shovel 108 or processing site 110 in a navigation system. Once the autonomous vehicle 102 is activated, the method may proceed to 610.

At 610, the computing system 400 may determine whether the autonomous vehicle 104 requires maintenance. The processor 402 may use information provided by the one or more inputs 404 to determine whether the autonomous vehicle 104 requires maintenance. If the processor 402 determines that the autonomous vehicle 104 does not require maintenance, the method may proceed to 612. The processor 402 may determine that the autonomous vehicle does not require maintenance if none of the sensors, for example, generate signals indicative of a vehicle problem. Additionally, the processor 402 may use information provided by the sensors to calculate other relevant parameters of the health of the vehicle. If these other vehicle health parameters also do not indicate a vehicle problem, the processor 402 may determine that the autonomous vehicle 104 does not require maintenance.

At 612, the processor 402 may execute the instructions received from the computing system 300. Such instructions may include to which shovel 108 or processing site 110 the autonomous vehicle 104 should travel. Additionally, the instructions may include instructions regarding which route the autonomous vehicle 104 may travel to reach the shovel 108 or the processing site 110. Thus, to execute these instructions, the processor 402 may instruct the one or more outputs 406 to move the autonomous vehicle 104 to the directed shovel 108 or the processing site 110 using the route, if any, provided by the computing system 300. While the computing system 400 executes the received instructions, the method may proceed to 614.

At 614, the computing system 400 may transmit state, location, travel, and vehicle health information regarding the autonomous vehicle 104 to the computing system 300. For example, the one or more inputs 404 may provide signals to the processor 402 regarding the state of the autonomous vehicle 104. For example, the one or more inputs 404 may provide information relating to whether the autonomous vehicle 104 is loaded or empty and, if it is loaded, whether the autonomous vehicle 104 is loaded with mined material or with waste. Alternatively, or additionally, the one or more inputs 404 may provide geographic location information to the processor 402. Location information may be collected using a GNSS receiver mounted to the autonomous vehicle 104. Alternatively, or additionally, the one or more inputs 404 may provide signals to the processor 402 indicative of travel information. Such travel information may include the speed of the autonomous vehicle 104, the direction of travel of the autonomous vehicle 104, or both. Additional information related to the travel of the autonomous vehicle 104 may also be transmitted to the computing system 300. All, or a portion of this information, may be transmitted from the autonomous vehicle 104 to the computing system 300.

Returning to 610, if the computing system 400 determines that the vehicle 104 does require maintenance, the method may proceed to 616. For example, the computing system 400 may determine that the vehicle 104 requires maintenance based on information received from the vehicle 104. The processor 402 may receive information from various inputs 404. The various inputs 404 may include various sensors. These sensors may include, but are not limited to, an engine coolant temperature sensor, a Hall effect sensor, a Manifold Absolute Pressure (MAP) sensor, a mass flow sensors, an oxygen sensor, a parking sensor, a speedometer, a tire-pressure monitoring sensor, and a water sensor. The computing system 400 may determine, for example, that the engine of the vehicle 104 is too hot. The computing system 400 may make this determination based on information provided by the engine coolant temperature sensor, for example. Alternatively, or additionally, the computing system 400 may calculate the number of tons of material transported per hour per mile, for example. If the calculated number of tons of material transported per hour per mile exceeds a threshold for the tires of the vehicle 104, the computing system 400 may determine that the vehicle 104 requires maintenance. If the computing system 400 determines, based on, for example, information provided by the one or more inputs 404, that the vehicle 104 requires maintenance, the method may proceed to 616.

At 616, the processor 402 may generate a signal indicating that the autonomous vehicle 104 requires maintenance. This signal may then be transmitted to the computing system 300 at the central site 102 via the transceiver 410. The signal may be transmitted via wired, wireless, or wired and wireless means. Additionally, the signal may be propagated to the computing system 300 through several intermediaries. Such intermediaries may include routers, switches, and servers. After the signal has been transmitted, the method may proceed to 618.

At 618, the autonomous vehicle 104 may travel to a maintenance station for maintenance. One or more maintenance stations may be located throughout a work site 100. Technicians at a maintenance station may perform preventive maintenance or repairs on the autonomous vehicle 104. For example, a technician at a maintenance station may read information provided by the sensors, for example. Based on this information, the technician may be able to diagnose any current or potential future problems with the autonomous vehicle 104. The technician may read this information on a display mounted on the autonomous vehicle 104 or the technician may read this information via a diagnostic tool which may be removably attached to the computing system 400. The technician may perform maintenance to repair any current issues with the autonomous vehicle 104, such as replacing worn out tires, or the technician may perform preventive maintenance, such as performing an oil change. After undergoing maintenance, the autonomous vehicle 104 may be ready for operation.

Returning to 606, if the computing system 400 determines that the autonomous vehicle 104 is active, the method may proceed to 620. The computing system 400 may determine that the autonomous vehicle 104 is active when it is transporting material from the shovel 108 to the processing site 110. For example, a load cell may be coupled to the autonomous vehicle 104 to measure if a force is being applied by any loaded material. Hydraulic load cells, pneumatic load cells, and strain gauge load cells may be used. Additionally, the computing system 400 may determine that the autonomous vehicle 104 is active when it is travelling from the processing site 110 to the shovel 108.

At 620, the computing system 400 determines whether the autonomous vehicle 104 requires maintenance. The analysis to determine whether the autonomous vehicle 104 requires maintenance 620 is analogous to the analysis whether the autonomous vehicle 104 requires maintenance 610, as described above. If the computing system 400 determines that the autonomous vehicle 104 does not require maintenance, the method may proceed to 622.

At 622, the computing system 400 may execute the received instructions. Such instructions may include to which shovel 108 or processing site 110 the autonomous vehicle 104 should travel. Additionally, the instructions may include instructions regarding which route the autonomous vehicle 104 may follow to reach the shovel 108 or the processing site 110. Thus, to execute these instructions, the processor 402 may instruct the one or more outputs 406 to move the autonomous vehicle 104 to the directed shovel 108 or the processing site 110 using the route, if any, provided by the computing system 300. The method may then proceed to 624.

At 624, the computing system 400 transmits state, location, travel, and health information to the computing system 300. For example, the one or more inputs 404 may provide signals to the processor 402 regarding the state of the autonomous vehicle 104. For example, the one or more inputs 404 may provide information relating to whether the autonomous vehicle 104 is loaded or empty and, if it is loaded, whether the autonomous vehicle 104 is loaded with mined material or with waste. Alternatively, or additionally, the one or more inputs 404 may provide geographic location information to the processor 402. Location information may be collected using a GNSS receiver mounted to the autonomous vehicle 104. Alternatively, or additionally, the one or more inputs 404 may provide signals to the processor 402 indicative of travel information. Such travel information may include the speed of the autonomous vehicle 104, the direction of travel of the autonomous vehicle 104, or both. Additional information related to the travel of the autonomous vehicle 104 may also be transmitted to the computing system 300. All, or a portion of this information, may be transmitted from the autonomous vehicle 104 to the central site 102.

Returning to 620, if the computing system 400 determines that the autonomous vehicle 104 does require maintenance, the method may proceed to 626. For example, the computing system 400 may determine that the vehicle 104 requires maintenance based on information received from the autonomous vehicle 104. The processor 402 may receive information from various inputs 404. The various inputs 404 may include various sensors. These sensors may include, but are not limited to, an engine coolant temperature sensor, a Hall effect sensor, a Manifold Absolute Pressure (MAP) sensor, a mass flow sensors, an oxygen sensor, a parking sensor, a speedometer, a tire-pressure monitoring sensor, and a water sensor. The computing system 400 may determine, for example, that the engine of the autonomous vehicle 104 is too hot. The computing system 400 may make this determination based on information provided by the engine coolant temperature sensor, for example. Alternatively, or additionally, the computing system 400 may calculate the number of tons of material transported per hour per mile, for example. If the calculated number of tons of material transported per hour per mile exceeds a threshold for the tires of the vehicle 104, the computing system 400 may determine that the autonomous vehicle 104 requires maintenance. If the computing system 400 determines, based on, for example, information provided by the one or more inputs 404, that the autonomous vehicle 104 requires maintenance, the method may proceed to 626.

At 626, the processor 402 may generate a signal indicating that the autonomous vehicle 104 requires maintenance. This signal may then be transmitted to the computing system 300 at the central site 102 via the transceiver 410. The signal may be transmitted via wired, wireless, or wired and wireless means. Additionally, the signal may be propagated to the computing system 300 through several intermediaries. Such intermediaries may include routers, switches, and servers. After the signal has been transmitted, the method may proceed to 628.

At 628, the autonomous vehicle 104 may travel to a maintenance station for maintenance. One or more maintenance stations may be located throughout a work site 100. Technicians at a maintenance station may perform preventive maintenance or repairs on the autonomous vehicle 104. For example, a technician at a maintenance station may read information provided by the sensors, for example. Based on this information, the technician may be able to diagnose any current or potential future problems with the autonomous vehicle 104. The technician may read this information on a display mounted on the autonomous vehicle 104 or the technician may read this information via a diagnostic tool which may be removably attached to the computing system 400. The technician may perform maintenance to repair any current issues with the autonomous vehicle 104, such as replacing worn out tires, or the technician may perform preventive maintenance, such as performing an oil change. After undergoing maintenance, the autonomous vehicle 104 may be ready for operation.

For example, this method may be executed by an autonomous vehicle 104 within a mining work site. If the autonomous vehicle 104 is inactive or idle, and it receives instructions from the computing system 300 located at the central site 102, the autonomous vehicle 104 becomes activated via activate switch 412. After becoming activated, the autonomous vehicle determines whether it requires maintenance, as described above. If the autonomous vehicle 104 determines that it requires maintenance, the autonomous vehicle 104 may generate and transmit a signal to the computing system 300 located at the central site 102 notifying the computing system 300 that the autonomous vehicle 104 requires maintenance. The autonomous vehicle 104 may then travel to a maintenance station to undergo maintenance, as described above.

However, if the autonomous vehicle 104 does not require maintenance, the computing system 400 of the autonomous vehicle 104 may execute the instructions received from the computing system 300. For example, the autonomous vehicle 104 may travel to a shovel 108. The shovel 108 may load the autonomous vehicle 104 with mined ore. Then, the autonomous vehicle 104 may travel to a processing site 110 to unload the mined ore. While the autonomous vehicle 104 is executing the instructions, the computing system 400 may also transmit state, location, travel, and vehicle health information to the computing system 300, as described above.

If the autonomous vehicle 104 is already active, in other words, it is currently transporting mined ore from a shovel 108 to a processing site 110 or returning from a processing site 110 to a shovel 108, the computing system 400 determines whether the autonomous vehicle 104 needs maintenance. The computing system 400 may make this determination based on, for example, information provided by various vehicle sensors. If the computing system 400 determines that the autonomous vehicle 104 requires maintenance, the autonomous vehicle 104 may generate and transmit a signal to the computing system 300 located at the central site 102 notifying the computing system 300 that the autonomous vehicle 104 requires maintenance. The autonomous vehicle 104 may then travel to a maintenance station to undergo maintenance, as described above.

However, if the autonomous vehicle 104 does not require maintenance, the computing system 400 of the autonomous vehicle 104 may execute the instructions received from the computing system 300. For example, the autonomous vehicle 104 may travel to a shovel 108. The shovel 108 may load the autonomous vehicle 104 with mined ore. Then, the autonomous vehicle 104 may travel to a processing site 110 to unload the mined ore. While the autonomous vehicle 104 is executing the instructions, the computing system 400 may also transmit state, location, travel, and vehicle health information to the computing system 300.

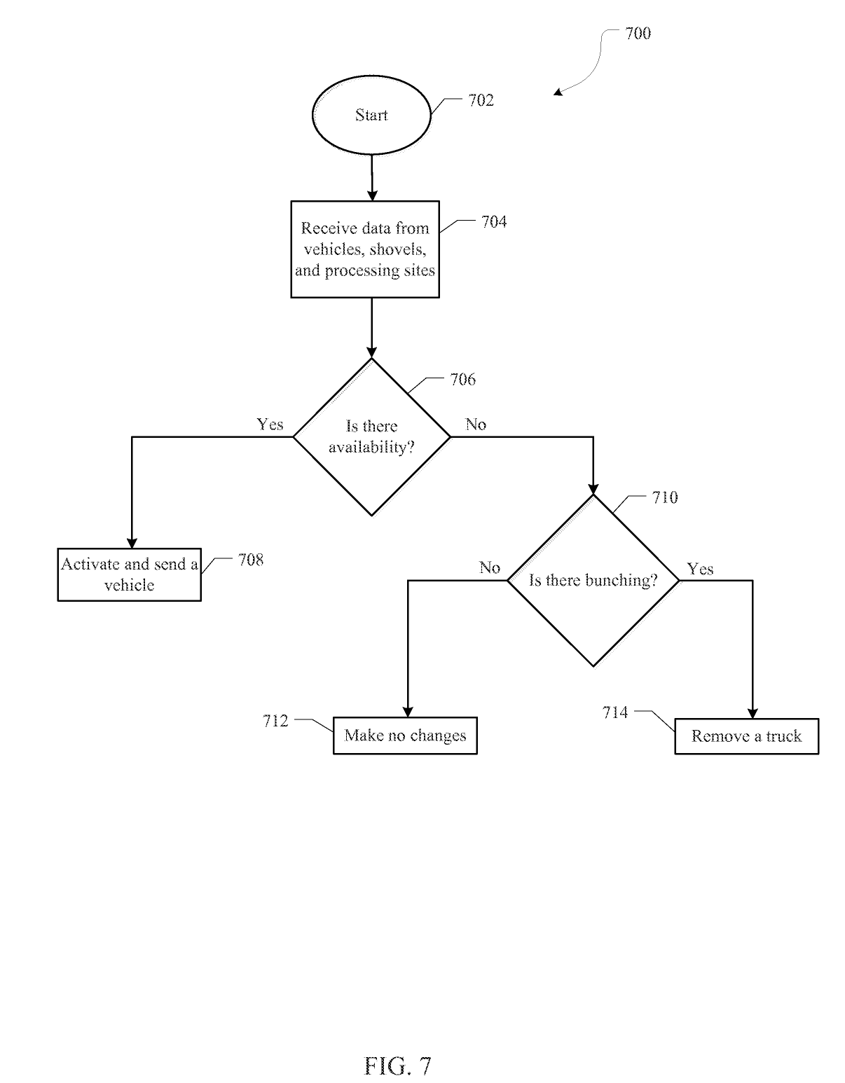

FIG. 7 is a flowchart 700 executed by the computing system 300 located at the central site 102, according to one aspect of this disclosure. The method begins at 702 and may proceed to 704.

At 704, the computing system 300 receives and collects data from the autonomous vehicles 104, the non-autonomous vehicles 106, the shovels 108, and the processing sites 110. The computing system 300 may receive and collect the state, location, travel, and health information from the autonomous vehicles 104 and the non-autonomous vehicles 106. The computing system 300 also may receive performance metrics for a shovel 108 or a processing 110 to service a vehicle 104 or 106. After receiving and collecting the data, the method may then proceed to 706.

At 706, the computing system 300 determines the availability of the shovels 108 and the processing sites 110 to accept autonomous vehicles 108 or non-autonomous vehicles 110. For example, the shovel 108 and the processing site 110 may transmit historical and real-time performance metrics. Based on these metrics, the processor 302 may calculate the average loading time of a shovel 108 or the average unloading time of a processing site 110. For example, the processor 302 may calculate that the shovel 108 loads an autonomous vehicle 104 or a non-autonomous vehicle 106 every 1.5 minutes. The processor 302 may make a similar calculation regarding the unloading time of a processing site 110.

The processor 302 may use the state information provided by the autonomous vehicles 104 and the non-autonomous vehicles 106 to determine the availability of the autonomous vehicles 104. For example, if the autonomous vehicle 104 transmits data indicating that it is empty, then the processor 302 may use this data to determine that the autonomous vehicle 104 is available to be used. Alternatively, if the autonomous vehicle 104 transmits data indicating that it is carrying material, for example, ore or waste, then the processor 302 may determine that the autonomous vehicle 104 is not available to be used.

The processor 302 may also use the location and travel information of the autonomous vehicles 104 and the non-autonomous vehicles 106. For example, the processor 302 may use the location and travel information to determine the location, speed, and direction of all of the autonomous vehicles 104 and non-autonomous vehicles 106 within the work site 100. The processor 302 may use the speed and direction of the autonomous vehicles 104 and the non-autonomous vehicles 106 to calculate the time it would take for each of the vehicles 104 and 106 to travel to a shovel 108 or a processing site 110. The processor 302 may use the travel time information for each of the vehicles 104 and 106 to determine whether a shovel 108 or a processing site 110 will be underserved or overserved by vehicles 104 and 106. For example, the processor 302 may calculate that, based on the travel time for all of the vehicles 104 and 106, twenty minutes from the present time, a shovel 108 will experience a gap in vehicle 104 or 106 arrival. For example, there may be a three minute window where no vehicles 104 and 106 will service the shovel 108. Therefore, the shovel 108 will be underserved and thus the work site 100 will not be operating as efficiently as it could. Thus, if, based on the performance metrics provided by the shovel 108 or processing site 110, the shovel 108 loads a vehicle 104 or 106 or if the processing site 110 unloads a vehicle 104 or 106 every 1.5 minutes, then the processor 302 may calculate that an additional autonomous truck may be sent to the underserved shovel 108 or processing site 110 during the three minute window. Therefore, the shovel 108 may load one autonomous vehicle 104 or the processing site 110 may unload one autonomous vehicle 104 during the three minute window instead of being idle. Additionally, or alternatively, the processor 302 may calculate that at least one vehicle is waiting to service the shovel 108 or processing site 110. In other words, the shovel 108 or the processing site 110 may be currently overserved. However, based on the state, location, speed, and direction of travel information of the vehicles 104 and 106 in the work site, the processor 302 may determine that, while the shovel 108 or the processing site 110 is currently overserved, the shovel 108 or processing site 110 will be underserved in the future. Thus, the processor 302 may dispatch an autonomous vehicle 104 to ensure that the shovel 108 or the processing site 110 will not be underserved in the future. If the processor 302 determines that a shovel 108 or a processing site 110 may be underserved, the method may proceed to 708.

At 708, the processor 302 may transmit an instruction to an available autonomous vehicle 104 to activate itself if it is not already activated. Additionally, the processor 302 may transmit instructions to the autonomous vehicle 104 directing the autonomous vehicle 104 to the underserved shovel 108 or processing site 110. Additionally, the processor 302 may provide routing information to the autonomous vehicle 104. The routing information may include routes for the autonomous vehicle 104 to travel to reach the shovel 108 or the processing site 110 and directions to reach the processing site 110 from the shovel 108 or vice versa.

Returning to 706, if the processor 302 determines, based on the state, location, and travel information received from the autonomous vehicles 104 and the non-autonomous vehicles 106, that none of the shovels 108 or the processing sites 110 will be underserved, the method may proceed to 710. For example, the processor 302 may determine that none of the shovels 108 or processing sites 110 are underserved by vehicles 104 and 106 because, based on the state, location, and travel information received from the vehicles 104 and 106 and the performance metrics of the shovels 108 or processing sites 110, there will be no gaps in time when vehicles 104 and 106 are serving the shovel 108 or processing site 110.

At 710, the processor 302 determines whether any of the autonomous vehicles 104 or the non-autonomous vehicles 106 may currently be bunching together or may bunch together in the future. Vehicle bunching indicates that there are too many vehicles 104 and 106 active within the work site 100. Therefore, the work site 100 is incurring extra costs by using extra vehicles 104 and 106 which do not increase the productivity of the work site 100. The processor 302 may determine that there is vehicle bunching by, for example, using the state, location, and travel information provided by the vehicles 104 and 106. For example, there may be more than one vehicle 104 or 106 waiting to service a shovel 108 or a processing site 110. The processor 302 may interpret this situation as evidence of vehicle bunching. If the processor 302 determines that there is vehicle bunching, the method may proceed to 714.

At 714, the processor 302 may transmit instructions to one of the autonomous vehicles 104 to discontinue serving the shovel 108 or processing site 110. If the autonomous vehicle 104 is not carrying material, the transmitted instructions may include instructions to follow a different route to a location where the autonomous vehicle 104 may become idle. Alternatively, if the autonomous vehicle 104 is transporting material, the transmitted instructions may include instructions to complete transporting the materials. After the autonomous vehicle 104 transports the material to a processing site 110 and unloads the material, the autonomous vehicle 104 may follow a route to a location where the autonomous vehicle 104 may become idle. This would reduce the number of vehicles in use in the work site 100 and thus the cost of operating the work site 100.

Returning to 710, if the processor 302 determines that there is no vehicle bunching, the method may proceed to 712. For example, one manner the processor 302 may determine if there is bunching at a shovel 108 or a processing site 110 is by analyzing the state, location, and travel information provided by the vehicles 104 and 106. For example, the processor 302 may determine that a vehicle 104 or 106 is currently at a shovel 108. Additionally, the processor 302 may have computed that it takes roughly 1.5 minutes for the shovel 108 to load a vehicle 104 or 106. The processor 302 may then calculate the time it will take for the next vehicle 104 or 106 to reach the shovel 108. If the processor 302 calculates that the next vehicle 104 or 106 will reach the shovel 108 in 1.5 minutes, the processor may determine that there is no bunching at the shovel 108. The processor 302 may determine that there is no bunching at the shovel 108 because the next vehicle 104 or 106 arriving at the shovel 108 will not arrive until after the current vehicle 104 or 106 at the shovel 108 has been loaded. Therefore, no vehicles 104 or 106 will be waiting at the shovel 108 while another vehicle 104 or 106 is being loaded.

At 712, since there are no available shovels 108 or processing sites 110 and there is no vehicle bunching, the processor 302 does not change the operation of the work site 100. For example, since there are no available shovels 108 or processing sites 110, the processor 302 may not need to generate and transmit instructions to an autonomous vehicle 104 to activate and follow a route to an available shovel 108 or processing site 110, as explained above. Additionally, since there may be no vehicle bunching within the work site 100, the processor 302 may not need to generate and transmit instructions to an autonomous vehicle 104 to become idle, as explained above.

For example, this method may be executed by a computing system 300 located at a central site 102 at a mining work site. The computing system 300 may receive data transmitted by the autonomous vehicles 104, non-autonomous vehicles 106, shovels 108, and processing sites 110. The computing system 300 may use the received data to determine whether a shovel 108 or a processing site 110 is available to service a vehicle 104 or 106. For example, the computing system 300 may determine when vehicles 104 or 106 will arrive at a shovel 108 or processing site 110. For example, the computer system 300 may use the location and travel information provided by the vehicles 104 and 106. The computing system 300 may use the location information to determine where in the mining work site the vehicles 104 and 106 are. Additionally, the computing system 300 may use travel information of the vehicles 104 and 106 to determine in which direction and at what speed the vehicles 104 and 106 are travelling. Thus, the computing system 300 may calculate how long it may take for a vehicle 104 or 106 to travel from the location it is currently at to a shovel 108 or a processing site 110. The computing system 300 may also use the information provided by the shovel 108 or processing site 110 to determine how long it takes for the shovel 108 to load a vehicle 104 or 106 and the processing site 110 to unload a vehicle 104 or 106. The computing system 300 may make this determination based on the information provided by the shovel 108 and processing site 110. For example, the shovel 108 and processing site 110 may collect information regarding how quickly it services a vehicle 104 and 106. Thus, for example, if a shovel 108 indicates that it loads a vehicle every 1.5 minutes and the computing system 300 determines, based on the location and travel information of the vehicles 104 and 106, that there will be a three minute gap of vehicles serving the shovel 108, for example, the computing system may determine that an additional autonomous vehicle 104 may be activated and instructed to travel to the shovel in the three minute gap. Thus, the autonomous vehicle 104 will fill the gap at the shovel 108.

Alternatively, the computing system 300 may determine that too many vehicles 104 and 106 are active within the mining work site. The computing system 300 may make this determination based on the location and travel information received from the vehicles 104 and 106. For example, the computing system 300 may determine that too many vehicles are serving a shovel 108, for example, if more than one vehicle 104 or 106 is waiting at the shovel 108. The same analysis may be made with respect to processing sites 110. If the computing system 300 determines that there are too many active vehicles 104 and 106 within the mining work site, then the computing system 300 may instruct at least one of the autonomous vehicles 104 to deactivate. However, if the computing system 300 determines that there are not too many vehicles 104 and 106 in the mining work site, the computing system 300 does not send an instruction to activate or deactivate an autonomous vehicle 104.

### INDUSTRIAL APPLICABILITY

This system and method relates generally to managing an autonomous fleet of vehicles. The system may include a computing system 300 located at a central site 102 in a work site 100. Alternatively, the computing system 300 may be located remotely from the work site 100. The work site 100 may also have a fleet of autonomous vehicles 104 and non-autonomous vehicles 106. Additionally, the work site 100 may have a plurality of shovels 108 and a plurality of processing sites 110. The autonomous vehicles 104 and non-autonomous vehicles 106 may each have a computing system 400 which may communicate with computing system 300. Also, the plurality of shovels 108 and the plurality of processing sites 110 may each have a computing system which may communicate with computing system 300.

The computing systems 400 of the vehicles 104 and 106, the shovels 108, and the processing sites 110 gather and transmit data about their operating status to the computing system 300. The computing system 300 uses the received data to determine the status of the work site 100. The computing system 300 uses the data provided by the shovels 108 and the processing sites 110 to determine how frequently the shovel 108 or the processing site 110 services a vehicle 104 or 106.

The computing system 300 may also determine, using the information provided by the autonomous vehicles 104 and the non-autonomous vehicles 106, where each vehicle 104 and 106 is in the work site 100. The computing system 300 may use data relating to the state of each of the vehicles 104 and 106 to determine whether it is active in transporting material or if it is idle. The computing system 300 may use data relating to the location and travel information of each of the vehicles 104 and 106 to determine where each of the vehicles 104 and 106 is in the work site 100 and how long it would take for a given vehicle 104 and 106 to reach a given shovel 108 or processing site 110. The computing system 300 may use data relating to vehicle health to determine whether any maintenance may be needed.

Based on how frequently the shovels 108 and the processing sites 110 service vehicles 104 and 106 and the estimated time it takes for vehicles 104 and 106 to reach the shovels 108 and processing sites 110, the computing system 300 may determine that a given shovel 108 or a processing site 110 will experience a gap in servicing vehicles 104 and 106 in the future. To fill the gap, the computing system 300 may activate and deploy an autonomous vehicle 104. In contrast, if the computing system 300 determines that a given shovel 108 or a processing site 110 will experience vehicle bunching in the future, the computing system 300 may remove one or more autonomous trucks 104 from the work site 100.

The system and process may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, Long Term Evolution (LTE), EVolution-Data Optimized (EVDO) and/or the like, and/or a combination of two or more thereof.

The system and process may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

Further in accordance with various aspects of the disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

The many features and advantages of the disclosure are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

I claim:

1. A method for managing a fleet of vehicles, the method comprising:
receiving data regarding a work site at an electronic processing unit at a first location, wherein the work site comprises a plurality of vehicles; and
determining, at the electronic processing unit and in response to the received data, whether a second location in the work site is available to service a vehicle,
dispatching, via the electronic processing unit, at least one autonomous vehicle to the second location if the second location in the work site is underserved by vehicles, and
deactivating, via the electronic processing unit, at least one autonomous vehicle serving the second location if the second location in the work site is overserved by vehicles.

2. The method for managing a fleet of vehicles of claim 1, the method further comprising calculating a rate at which the second location in the work site services vehicles.

3. The method for managing a fleet of vehicles of claim 1, wherein the received data further comprises a vehicle state, vehicle location, vehicle travel, and vehicle health information.

4. The method for managing a fleet of vehicles of claim 1, the method further comprising determining, in response to the received data, an availability of the autonomous vehicle.

5. The method for managing a fleet of vehicles of claim 4, wherein determining the availability of the autonomous vehicle further comprises determining whether the autonomous vehicle is carrying material or whether the autonomous vehicle requires maintenance.

6. The method for managing a fleet of vehicles of claim 1, wherein the second location loads mined material onto a vehicle or unloads mined material from a vehicle.

7. The method for managing a fleet of vehicles of claim 1, the method further comprises:
dispatching at least one autonomous vehicle when the second location is currently overserved by vehicles but will be underserved by vehicles at a future time.

8. The method for managing a fleet of vehicles of claim 1, wherein the method determines whether the second location in the work site is available to service a vehicle based on a calculated location, speed, and direction of travel of vehicles of the work site.

9. The method for managing a fleet of vehicles of claim 1, the method further comprising providing a route to the at least one autonomous vehicle to travel to reach the second location.

10. The method for managing a fleet of vehicles of claim 1, wherein the autonomous vehicle is remotely activated.

11. A system for managing a fleet of vehicles, the system comprising:
a work site comprising a plurality of vehicles;
a plurality of autonomous vehicles, each autonomous vehicle comprising an electronic processing unit configured to transmit data to a second location;
a first location with an electronic processing unit configured to transmit data to the second location; and
the second location with an electronic processing unit configured to determine, in response to the data transmitted by the plurality of autonomous vehicles and the first location, whether the first location is available to service a vehicle, the electronic processing unit of the second location is further configured to dispatch at least one autonomous vehicle to the first location if the first location in the work site is underserved by vehicles, and to deactivate at least one autonomous vehicle serving the first location if the first location in the work site is overserved by vehicles.

12. The system for managing a fleet of vehicles of claim 11, wherein the electronic processing unit of the second location is further configured to calculate a rate at which the first location services a vehicle.

13. The system for managing a fleet of vehicles of claim 11, wherein the data transmitted by the plurality of autonomous vehicles comprises a state, location, travel, and vehicle health information.

14. The system for managing a fleet of vehicles of claim 11, wherein the electronic processing unit of the second location is further configured to determine, in response to the data transmitted by the plurality of autonomous vehicles, an availability of the autonomous vehicle.

15. The system for managing a fleet of vehicles of claim 14, wherein the electronic processing unit of the second location is further configured to determine the availability of the autonomous vehicle based on whether the autonomous vehicle is carrying material or whether the autonomous vehicle requires maintenance.

16. The system for managing a fleet of vehicles of claim 11, wherein the first location loads mined material onto a vehicle or unloads mined material from a vehicle.

17. The system for managing a fleet of vehicles of claim 11, wherein the electronic processing unit of the second location dispatches at least one autonomous vehicle when the first location is currently overserved by vehicles but will be underserved by vehicles at a future time.

18. The system for managing a fleet of vehicles of claim 11, wherein the electronic processing unit of the second location is further configured to determine whether the first location is available to service a vehicle based on a calculated location, speed, and direction of travel of vehicles of the work site.

19. The system for managing a fleet of vehicles of claim 11, wherein the electronic processing unit of the second location is further configured to transmit a route to at least one of the plurality of the autonomous vehicles to travel to reach the first location.

20. The system for managing a fleet of vehicles of claim 11, wherein the electronic processing unit of the second location is further configured to transmit an activation signal to the plurality of autonomous vehicles.
